(19) United States
(12) Patent Application Publication
(10) Pub. No.: US 2015/0078869 A1
(43) Pub. Date: Mar. 19, 2015

(54) MOBILE SERVICE TRAILER WITH CRANE

(71) Applicant: Edwin PLEWES, Grande Prairie (CA)

(72) Inventor: Edwin PLEWES, Grande Prairie (CA)

(21) Appl. No.: 14/026,329

(22) Filed: Sep. 13, 2013

(51) Int. Cl. B60P 1/54; B60P 3/14

(52) U.S. Cl. CPC B60P 1/5438; B60P 3/14
USPC 414/542

(57) ABSTRACT

A mobile service trailer having structural support columns extending vertically from a trailer platform and roof support members which are supported by the support columns and span the width of the trailer platform. A first guide track is suspended underneath and extends between the roof support members. A first crane is positioned on an elongated trolley which travels along the first guide track between an extended position and a retracted position. In the extended position, the trolley extends past the rear end of the trailer platform in a cantilever fashion to enable the first crane to reach and lift an object positioned behind the trailer platform. In the retracted positioned, the trolley is retracted to enable the first crane to deposit the object onto the trailer platform.

### FIELD

There is described a mobile service trailer, which has a built in crane.

### BACKGROUND

Mobile service trailers are frequently used to transport equipment to job sites. However, without lifting capacity the mobile service trailer can only be used to service objects that can be manually lifted into the trailer. What is required is a mobile service trailer with lifting capacity.

### SUMMARY

There is provided a mobile service trailer with crane which has a trailer platform resting upon ground engaging wheels. The trailer platform has a front end, a rear end, a first side, a second side, and a trailer hitch support extending forward of the front end. A plurality of structural support columns extend vertically from the trailer platform at spaced intervals along both of the first side and the second side. A plurality of roof support members are supported by the support columns and span the width of the platform between the first side and the second side. A first guide track is suspended underneath and extends between the roof support members. A first crane is positioned on an elongated trolley which travels along the first guide track between an extended position and a retracted position. In the extended position, the trolley extends past the rear end of the trailer platform in a cantilever fashion to enable the first crane to reach and lift an object positioned behind the trailer platform. In the retracted positioned, the trolley is retracted to enable the first crane to deposit the object onto the trailer platform.

The mobile service trailer, described above, can be backed up to a piece of equipment needed servicing. The trolley can then be extended in cantilever fashion over the piece of equipment and the first crane can be used to lift it. The trolley can then be retracted, so that the piece of equipment can be lowered onto the trailer platform adjacent to the work station where the piece of equipment is to be serviced. There are various ways of configuring the first guide track. Beneficial results have been obtained when the roof support members have a depending framework and the first guide track is defined by a channel defined by the framework which accommodates the trolley.

For some pieces of equipment, servicing requires multiple work stations. In such a situation, it may be necessary to repeatedly reposition the piece of equipment on the trailer platform to access different work stations. In such cases, a second guide track may be provided extending between the front end and the rear end, with the second guide track being supported by the support columns. A second crane can then be positioned on a beam that extends across the trailer platform between the first side and the second side. The second crane is capable of travelling along the beam between the first side and the second side. The beam is capable of travelling along the second guide track between the front end and the rear end. This enables the second crane is able to lift the object deposited by the first crane and reposition the object axially and laterally to any desired location on the trailer platform. There are various ways in which the second guide track can be configured. Beneficial results have been obtained when the support columns have an upper ledge and the second guide track is comprised of parallel crane rails. One of the crane rails is positioned on the upper ledge of the support columns the first side of the trailer platform and another of the crane rails positioned on the upper ledge of the support columns on the second side of the trailer platform.

It is preferred that the trailer platform be is enclosed by sheeting secured to an outside of the support columns and roof support members. The reason this is preferred is that it provides a working environment that is sheltered from the elements and it provides better security against trespass and theft of tools. It will be appreciated, however, that the trailer platform need not be enclosed.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a mobile service trailer.

FIG. 2 is a detailed side elevation view of the mobile service trailer of FIG. 1 with trolley partially extended to position the first crane.

FIG. 3 is a rear elevation view of the mobile service trailer of FIG. 1 with the trolley retracted into the first guide track.

FIG. 4 is a top plan view, in section, of the mobile service trailer of FIG. 1 showing possible mobile service shop layout with various work stations.

FIG. 5 is an end elevation view, in section, of the mobile service trailer of FIG. 1 showing the second crane and the beam engaged on the second guide track.

### DETAILED DESCRIPTION

A mobile service trailer generally identified by reference numeral 10, will now be described with reference to FIG. 1 through 5.

### Structure and Relationship of Parts:

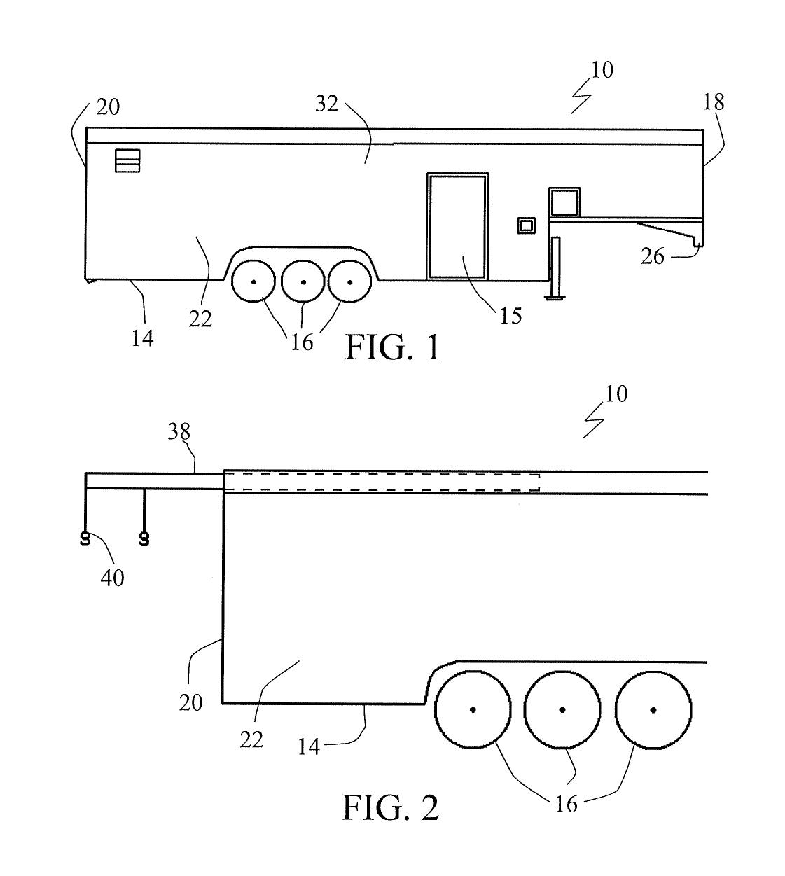

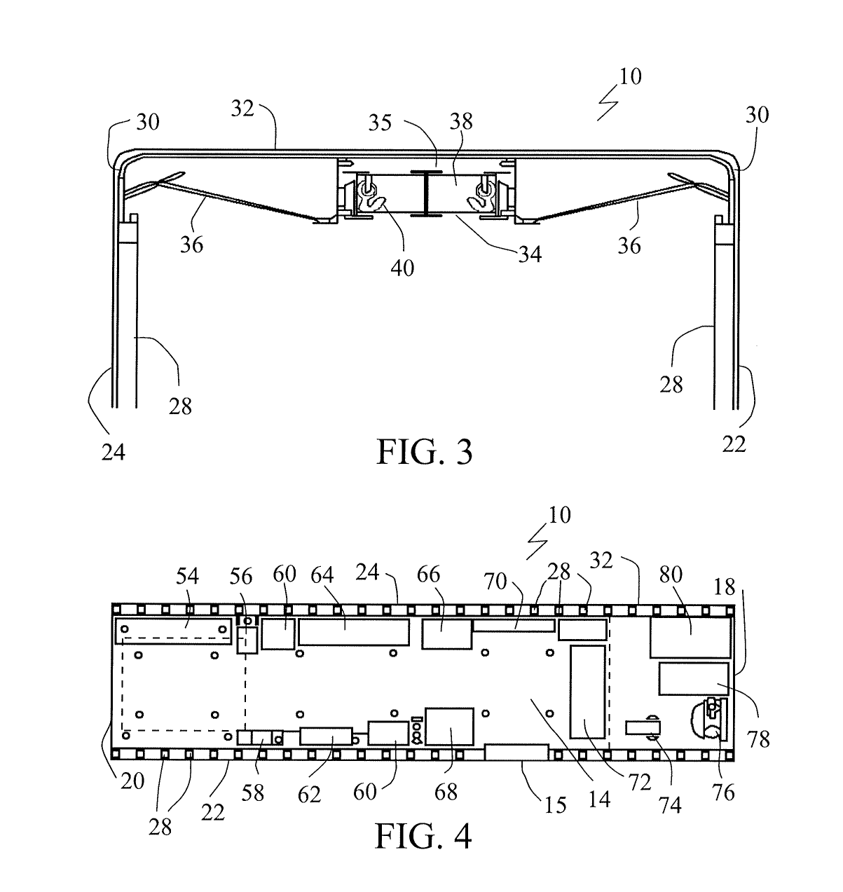

Referring to FIG. 1, a mobile service trailer with crane 10 has a trailer platform 14 resting upon ground engaging wheels 16. Trailer platform 14 has a front end 18, a rear end 20, a first side 22, a second side 24 (visible in FIG. 3 and FIG. 4), and a trailer hitch 26 support extending forward of front end 18. Mobile service trailer 10 may also have a side door 15 for personnel access. Referring to FIG. 3, a plurality of structural support columns 28 extend vertically from trailer platform 14 at spaced intervals along both of first side 22 and second side 24. A plurality of roof support members 30 supported by support columns 28 and spanning the width of platform 14 between first side 22 and second side 24. Trailer platform 14 may be enclosed by sheeting 32 around the outside of support columns 28 and roof support members 30. A first guide track 34 is suspended underneath roof support members 30. Roof support members 30 have depending framework 36 and first guide track 34 is defined by a channel 35 defined by framework 36 which accommodates trolley 38. A first crane 40 is positioned on trolley 38 which travels along first guide track 34 between an extended position and a retracted position. Referring to FIG. 2, in the extended position, trolley 38 extends past rear end 20 of trailer platform 14 in a cantilever fashion to enable first crane 40 to reach and lift an object positioned behind trailer platform 14. In the retracted positioned, trolley 38 is retracted to enable first crane 40 to deposit the object onto trailer platform 14.

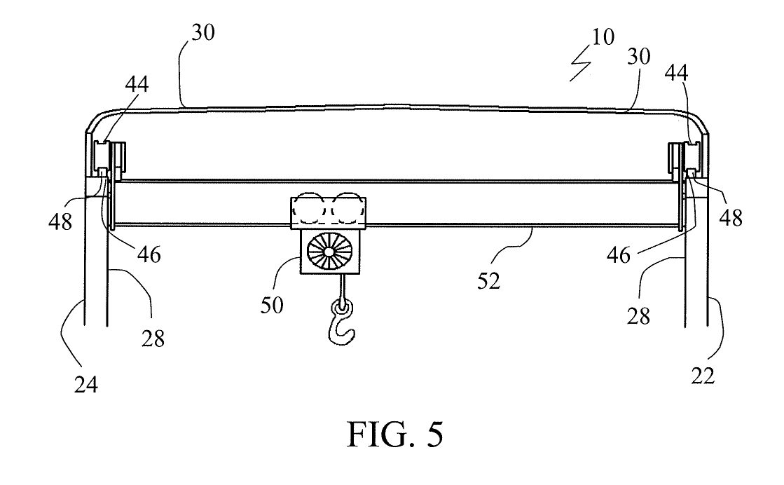

Referring to FIG. 5, mobile service trailer 10 has a second guide track 44 extending between front end 18 and rear end 20 and is supported by support columns 28. Support columns 28 have an upper ledge 46 and second guide track 44 is comprised of parallel crane rails 48 with one of crane rails 48 positioned on upper ledge 46 of support columns 28 on first side 22 of trailer platform 14 and another of crane rails 48 positioned on upper ledge 46 of support columns 28 on second side 24 of trailer platform 14. A second crane 50 is positioned on a beam 52 that extends across trailer platform 14 between first side 22 and second side 24. Second crane 50 travels along beam 52 between first side 22 and second side 24. Beam 52 travels along second guide track 44 between front end 18 and rear end 20, such that second crane 50 is able to lift the object deposited by first crane 40 and reposition the object axially and laterally to a desired location on trailer platform 14.

Referring to FIG. 4, mobile service trailer 10 may have several different work stations to allow an object to be worked on with different equipment. Work stations available in mobile service trailer 10 may include a work bench 54, a welder or plasma cutter 56, a band saw 58, welders 60, a hydraulic press 62, tool chests 64, a wash tank 66, a drill 68, bolt bins 70, a lathe 72, a pressure washer 74, an air compressor 76, a generator 78 and a fuel tank 80. It will be understood that other types of work stations and equipment may be positioned within mobile service trailer 10 depending upon what type of objects are to be worked on.

### Operation:

Referring to FIG. 1, mobile service trailer 10 is positioned such that rear end 20 of trailer 10 is near object to be lifted. Referring to FIG. 2, trolley 38 is extended past rear end 20 of trailer 10 to allow first crane 40 to be used to pick up objects. Once object has been picked up, trolley 38 is retracted to position object on trailer platform 14. Referring to FIG. 5, second crane 50 can then be used to reposition object to different work stations in mobile service trailer 10. Second crane 50 is movable along beam 52 between first side 22 and second side 24 of mobile service trailer 10 and beam 52 is movable along length of second guide track 44 to allow repositioning of object axially and laterally.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A mobile service trailer with crane, comprising:
a trailer platform resting upon ground engaging wheels, the trailer platform having a front end, a rear end, a first side, a second side, and a trailer hitch support extending forward of the front end;
a plurality of structural support columns extending vertically from the trailer platform at spaced intervals along both of the first side and the second side;
a plurality of roof support members supported by the support columns and spanning the width of the platform between the first side and the second side;
a first guide track suspended underneath and extending between the roof support members;
a first crane positioned on an elongated trolley which travels along the first guide track between an extended position and a retracted position, in the extended position the trolley extends past the rear end of the trailer platform in a cantilever fashion to enable the first crane to reach and lift an object positioned behind the trailer platform and in the retracted positioned the trolley is retracted to enable the first crane to deposit the object onto the trailer platform.

2. The mobile service trailer of claim 1, wherein the roof support members have depending framework and the first guide track is defined by a channel defined by the framework which accommodates the trolley.

3. The mobile service trailer of claim 1, wherein:
a second guide track extends between the front end and the rear end, the second guide track being supported by the support columns; and
a second crane is positioned on a beam that extends across the trailer platform between the first side and the second side, the second crane travelling along the beam between the first side and the second side, the beam travelling along the second guide track between the front end and the rear end, such that the second crane is able to lift the object deposited by the first crane and reposition the object axially and laterally to a desired location on the trailer platform.

4. The mobile service trailer of claim 3, wherein the support columns have an upper ledge and the second guide track is comprised of parallel crane rails with one of the crane rails positioned on the upper ledge of the support columns the first side of the trailer platform and another of the crane rails positioned on the upper ledge of the support columns on the second side of the trailer platform.

5. The mobile service trailer of claim 1, wherein the trailer platform is enclosed by sheeting secured to an outside of the support columns and roof support members.

6. A mobile service trailer with crane, wherein:
a trailer platform resting upon ground engaging wheels, the trailer platform having a front end, a rear end, a first side, a second side, and a trailer hitch support extending forward of the front end;
a plurality of structural support columns extending vertically from the trailer platform at spaced intervals along both of the first side and the second side;
a plurality of roof support members supported by the support columns and spanning the width of the platform between the first side and the second side;
a guide track extends between the front end and the rear end, the second guide track being supported by the support columns; and
a crane is positioned on a beam that extends across the trailer platform between the first side and the second side, the crane travelling along the beam between the first side and the second side, the beam travelling along the guide track between the front end and the rear end, such that the crane is able to reposition an object axially and laterally to a desired location on the trailer platform.

7. The mobile service trailer of claim 6, wherein the support columns have an upper ledge and the guide track is comprised of parallel crane rails with one of the crane rails positioned on the upper ledge of the support columns the first side of the trailer platform and another of the crane rails positioned on the upper ledge of the support columns on the second side of the trailer platform.
